(19) United States
(12) Patent Application Publication
(10) Pub. No.: US 2012/0227316 A1
(43) Pub. Date: Sep. 13, 2012

(54) PLANTING APPARATUS AND METHODS

(76) Inventor: BRENDA PTAK, KENT, OH (US)

(21) Appl. No.: 13/413,981

(22) Filed: Mar. 7, 2012

Related U.S. Application Data
(60) Provisional application No. 61/449,928, filed on Mar. 7, 2011.

(51) Int. Cl. A01G 9/02; A01G 13/02; A01C 7/00

(52) U.S. Cl. 47/32.3; 47/65.5; 47/66.6; 111/100

(57) ABSTRACT

The present invention is directed to improved planting pots and methods. Specifically, the invention provides methods and apparatuses that assist gardeners in transplant cultivation, plant protection and containment, garden organization, decoration, and plant identification.

### CROSS-REFERENCE TO RELATED APPLICATIONS

This application claims the benefit of U.S. Provisional Application No. 61/449,928, titled PLANTING APPARATUS AND METHODS, filed Mar. 7, 2011, which is herein incorporated by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

This invention relates generally to a planting apparatus and methods for planting.

2. Description of Related Art

Gardening consistently ranks amongst the most popular outdoor leisure activities of Americans. According to a recent National Gardening Association survey there are 90 million households in the United States with a yard and garden, and nearly 80 million of those households engaged in some sort of do-it-yourself lawn and garden activities in 2011. Thus, home gardening—whether it be a home food garden, flower garden, or any of the other varieties of gardening activities—is an increasingly popular hobby, and one ripe with opportunities for improved methods and tools.

Specifically, gardening enthusiasts could benefit from improved planting methods and planting apparatuses. Flower and vegetable gardening typically involves one of two planting and cultivating methods. In some instances, the gardener sows seeds directly into dirt or soil located in the ground, or in a prepared planting or flower pot, and then waters and fertilizes the seed into a mature plant (hereafter, “seed cultivation”). Still other gardeners prefer to transplant seedlings, or relatively more mature plants and their divisions and propagations, into the ground or a flower pot (hereafter. “transplant cultivation”). Sometimes, gardeners will cultivate seeds in planting pots until the plant is mature enough to be transplanted into the ground or a more decorative flower pot. More frequently, however, gardeners purchase seedlings or mature plants contained in a planting pot from a garden nursery or home and garden store. As used in this specification, the term “planting pot” is generally used to describe either a temporary seed cultivation pot or a disposable pot that holds a purchased seedling or plant, while the term “flower pot” is used to describe a more decorative and permanent home for the plant.

Gardeners who elect to create their garden through transplant cultivation have come to recognize various problems with existing methods and apparatuses. For example, the most common transplant cultivation planting method is where a purchased plant and a portion of soil commonly included and contained in the planting pot (together, the “root ball”) is removed from the planting pot and inserted into a hole dug into the ground. Gardeners are frequently instructed to dig a hole twice the size of the plant to be transplanted. When gardeners dig a transplant hole into the ground, however, it can be difficult to precisely and accurately define the location and parameters of the hole, and in the digging process soil frequently falls back into the area the gardener is attempting to evacuate of soil for planting (the “planting site”). Additionally, as a general rule well known to those of skill in the art, the planting pot is removed prior to transplantation into the ground because the planting pot which is, in the prior art, akin to a large cup—has a bottom portion that would unsatisfactorily impede root growth and expansion as the plant continues its natural maturation after transplant. Thus, planting pots are generally removed prior to transplantation and discarded.

When this practice is employed, however, if the root ball is not immediately placed in a hole in the ground after removal from the planting pot it can experience root drying or damage that harms its chances for long term survival. Also, the transplantation of the root ball into the ground, and the backfilling of soil—initially removed to create the hole—in the area surrounding the transplanted plant, can damage the plant's roots. Plus, most purchased planted pots contain relatively fertile soil that drains well; when the root ball is transplanted into the ground, gardeners have discovered that water does not stay in the desired location, near the roots contained in the fertile planting pot soil; instead, water drains away into backfilled soil, thereby depriving the plant of essential moisture and nutrients, hindering maturation, and decreasing the chances of survival.

But the transplant process is not the only area of concern for gardeners. Depending on the variety of plant intended to be grown, or transplanted, gardeners have come to recognize various problems associated with certain species. For example, an invasive plant species is one that—if its growth is not contained by pruning or physical barriers—can crowd out and overwhelm a garden area, killing neighboring cultivated plants in the process or aggressively expanding outside of the gardener's preferred or designated area. Still other plant species are of a more delicate nature, and need to be protected from the encroachment of both invasive and non-invasive species. Gardeners with an affection for bulbs or tubers can attest to the destruction of flower and vegetable beds caused by moles and other digging rodents, while many other plant species are vulnerable to insects or slugs.

And there are other areas gardeners generally recognize as having potential for improvements. Food gardeners frequently plant seedlings in close proximity when they are immature, only to encounter identification problems when the pants reach a mature size and have grown into relatively commingled indistinguishable vegetation. Group planting—for both aesthetic effect and to provide support for plants with taller morphologies—is generally recognized as preferable by gardeners, but could be improved by in-ground identification markers. And many gardeners, desiring to decorate their gardens with various aesthetic devices, would benefit from flower pots or other apparatuses capable of supporting decorative emblems and markers.

Therefore, what is needed is a planting apparatus which can be temporarily and/or permanently used, or installed into the ground, to improve the digging and transplant process. The present invention solves the problems of the prior art, and benefits gardeners with methods and apparatuses that assist in transplant cultivation, garden organization, decoration, and plant identification.

### BRIEF SUMMARY OF THE INVENTION

According to one embodiment of this invention, a planting apparatus has a wall having a first end and a second end surrounding a cavity adapted to receive a plant seed or root ball, wherein the wall's first end defines a first opening adapted to permit unobstructed plant root growth into the soil, and the wall's second end defines a second opening adapted to permit unobstructed growth of the plant's stem in an upward direction; and a rim, adapted to securely transfer downward pressure, attached to the wall's second end and extending in a substantially perpendicular direction away from the cavity. When the planting apparatus is implanted or embedded into the ground, an opening in the second end provides space for a plant to grow upward out of the soil, while an opening in the first end allows the roots of the plant to extend downward into the soil beyond the boundaries of the first end.

According to another embodiment of the present invention, a method for planting a seed or root ball, comprises the steps of: A) providing a bottomless planting pot with a first end and a second end; B) placing the first end of the bottomless planting pot on a ground surface at a planting site; C) applying downward pressure to the planting pot's second end until the first end is at least partially inserted into the ground; D) removing the bottomless planting pot; E) removing all soil from the planting site; F) re-inserting the bottomless planting pot into the planting site; and G) planting a seed or root ball into the planting site.

According to yet other embodiments of the invention, a method for preventing slugs from damaging garden plants, comprises the steps of: A) providing a bottomless planting pot with a first end, a second end, and a curved rim; wherein the curved rim is attached to the second end on a perpendicular plane and curves towards the first end; B) placing the curved rim of the bottomless planting pot on a ground surface surrounding a planting site containing a plant; and C) filling the curved rim with beer to prevent slugs from migrating onto the plant.

One advantage of this invention is the rim which allows a user to apply a downward force to planting apparatus in order to easily and precisely locate and create a planting site. Another advantage is the planting apparatus can keep soil from falling back into the hole after the soil is removed. Another advantage is the planting apparatus can ensure the hole has the correct dimensions before planting. Another advantage are improvements in plant organization, identification, and decoration. Another advantage is the protection of delicate plants from surrounding aggressive or invasive plant species. Another advantage is the invention's ability to contain the growth of aggressively spreading or invasive species. Another advantage is the ability to keep mulch at the appropriate distance from the root ball. Another advantage is the better use of soil.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a top view of a planting apparatus, according to one embodiment;

FIG. 2 is a cross-sectional view of the planting apparatus shown in FIG. 1, according to one embodiment;

FIG. 3 is a side view of a planting apparatus positioned within the ground, according to one embodiment;

FIG. 4 is a side view of a planting apparatus positioned within the ground, according to one embodiment;

FIG. 5 is a side view of a planting apparatus partially located within the ground, according to one embodiment; and

FIG. 6 is a side view of a planting apparatus partially located within the ground, according to one embodiment.

FIG. 7 is a cross-sectional view of a planting apparatus according to one embodiment.

FIG. 8 is a cross sectional view of a planting apparatus according to one method of the present invention.

### DETAILED DESCRIPTION OF THE INVENTION

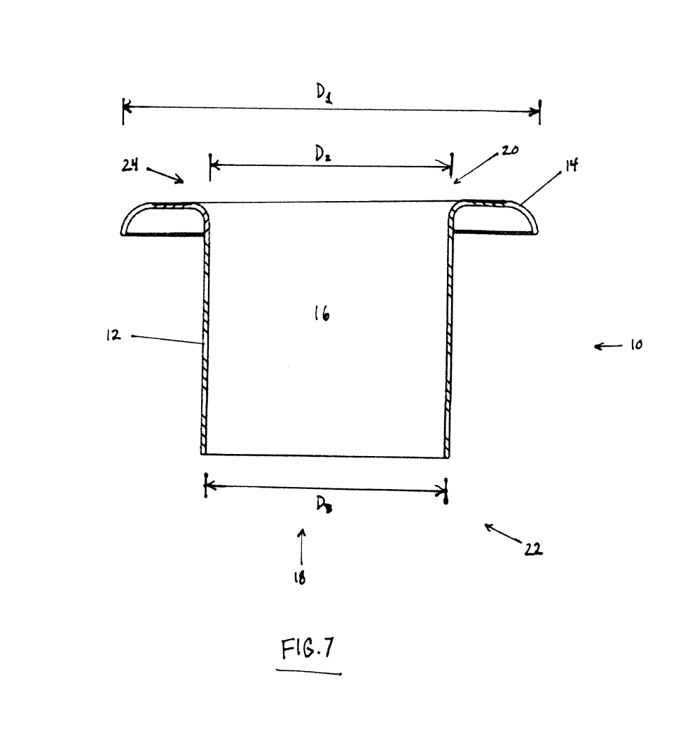

Referring now to the drawings wherein the showings are for purposes of illustrating embodiments of the invention only and not for purposes of limiting the same, and wherein like reference numerals are understood to refer to like components, FIG. 7 shows a bottomless planting apparatus 10, according to one embodiment. The planting apparatus 10 can be formed of plastic, metal, or any other rigid material chosen by a person of ordinary skill in the art. The planting apparatus 10 may included a wall 12 and a lip or rim 14. In some embodiments, the planting apparatus 10 is a unitary object comprising a wall 12 and rim 14. In some embodiments, as shown in FIGS. 2 and 7, the rim 14 is circular and has a cross-sectional curved shape and is on a plane substantially perpendicular to the wall 12; it extends in a substantially perpendicular direction away from the cavity. In some embodiments, the rim 14 is covered with a grip substance—chosen by a person of skill in the art—designed to impart improved grip characteristics to the rim when downward pressure is applied.

In a preferred embodiment, the wall 12 is substantially cylindrical and can surround a cavity 16 with openings 18, 20 of an equal size and diameter located at the first and second ends 22, 24 of the planting apparatus 10. In short, the preferred embodiment is similar to a planting pot that has no bottom—a bottomless planting pot. In other embodiments, the wall 12 can define a cavity 16 of various other shapes—as chosen by a person of ordinary skill in the art—including, but not limited to, square, rectangular, triangular (etc.). As a general proposition, the wall 12 assists the plant in retaining moisture. The cavity 16 is adapted and designed to receive either: (a) a seed and soil; or (b) a seedling and soil; or (c) a relatively mature garden plant and soil. The function of first opening 18 is to permit unobstructed growth of plant roots in a downward direction into the soil after the planting apparatus 10 is either temporarily, or permanently, installed with the plant into the ground. The function of second opening 20 is to permit the plant's stem, leaves, and flowers to grow in a substantially upright direction until maturity.

In some embodiments, the first end 22 of the wall 12 can include a sharpened edge. In other embodiments, the first end 22 of the wall 12 may include projections or serrations 28, as shown in FIGS. 3 and 5. The interior or exterior of the wall 12 can also optionally include a measurement gauge 36, as shown in FIG. 2. The measurement gauge 36 can include measurement lines in equally spaced increments. The measurement gauge 36 can include measurement lines at predefined locations. In one embodiment, the measurement gauge 36 includes measurement lines in ½″ increments.

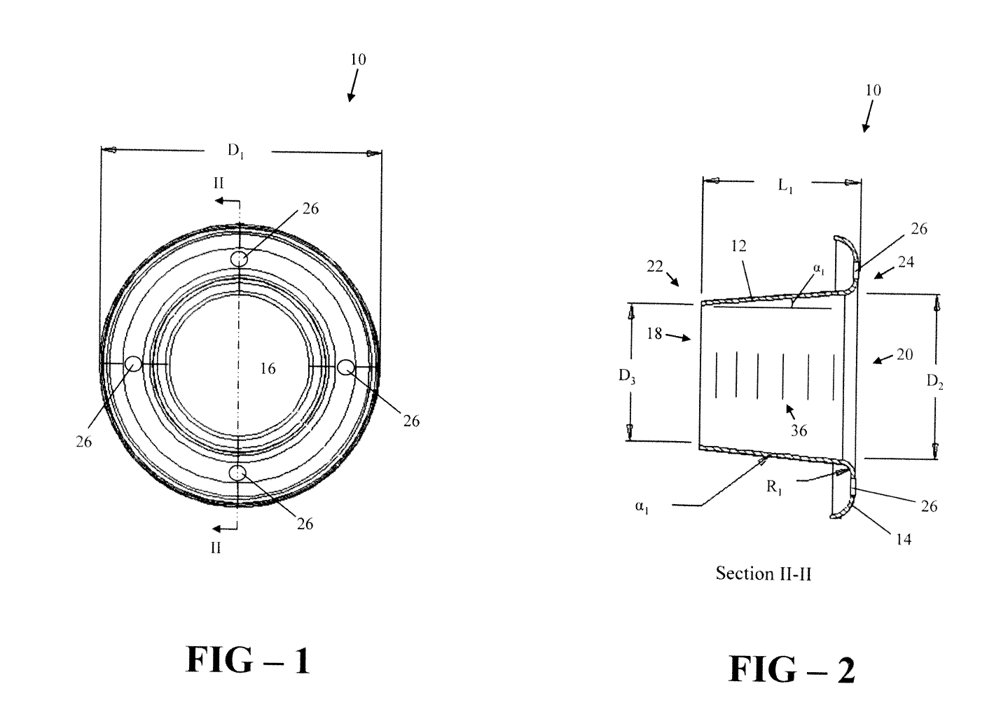

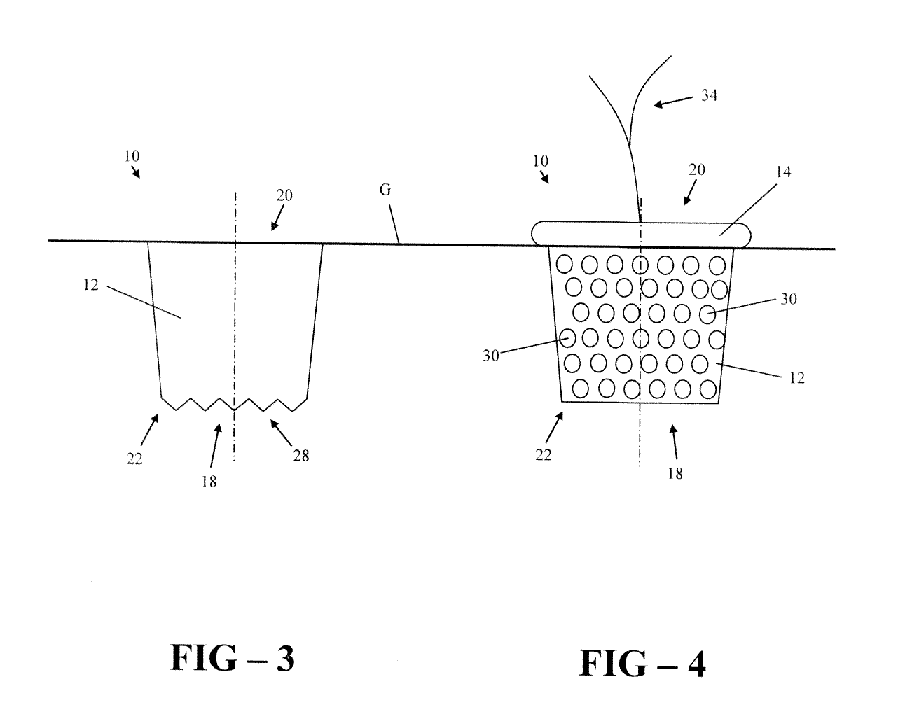

The wall 12 may also include one or more apertures 30, as shown in FIG. 4. The number of apertures 30, the size of each aperture 30, and the shape of each aperture 30 can vary depending upon the application. The apertures 30 can be all the same size and shape or the apertures 30 can be various sizes, shapes, or both. The apertures 30 can have a variety of shapes including, but not limited to, circular, oval, elliptical, square, rectangular, diamond, and triangular. These apertures 30 can serve several purposes or functions. The apertures 30 can reduce the amount of material required to form the planting apparatus 10. The apertures 30 can allow the roots of plant to spread substantially laterally from the sides of the planting apparatus 10. The apertures 30 can allow precipitation to enter or exit the planting apparatus providing water and nutrients to the plant 34. The wall 12 can include an embedded design 32, as shown in FIG. 5. The rim 14 can include one or more apertures 26, as shown in FIG. 1. The apertures 26 can receive plant identification tags, plant information tags, garden decorations including, but limited to figurines or images of birds, flowers, nautical figures, insects, fairies, frogs, dragonflies, breast cancer ribbons, seasonal decor, oceanic life, scarecrows, hearts, bows, lips, and poles with dangling items. The planting apparatus 10 can be substantially circular, as shown in FIGS. 1 and 7, or can have a variety of other shapes including, but not limited to, oval, elliptical, square, rectangular, and triangular.

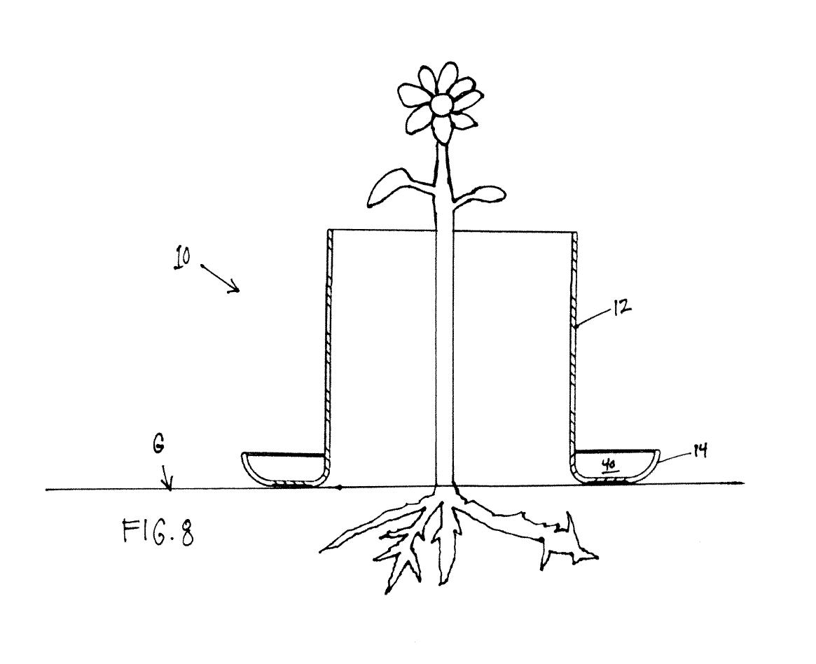

In some embodiments, the planting apparatus 10 can have the following dimensions: the outside diameter D₁ of the rim 14 can be of any size between approximately 6 and 12 inches; the inside diameter of the rim 14 and the diameter D₂ of the opening 20 can be of any size between approximately 3 and 9 inches; the diameter D₃ of the opening 18 can be of any size between approximately 3 and 9 inches; and the length L₁ of the planting apparatus 10 can be of any size between approximately 3 and 9 inches with a wall thickness of any size between approximately of 0.05 and 0.5 of an inch. In one embodiment, shown in FIG. 8, the planting apparatus has the following dimensions. The outside diameter D₁ of the rim 14 can be about 7.84 inches; the inside diameter of the rim 14 and the diameter D₂ of the opening 20 can be about 4.5 inches; the diameter D₃ of the opening 18 can be about 4.5 inches; and the length L₁ of the planting apparatus 10 can be about 4.75 inches with a wall thickness of about 0.09 of an inch. Many other dimensions and sizes are contemplated and are within the scope of this invention.

In some embodiments, generally shown in FIG. 1, the wall 12 may have a taper from second end 24 to first end 22. According to one specific embodiment, the wall 12 may have a taper angle α₁ of between about 0° and 10°. In some embodiments, the taper angle α₁ is between about 1° and 9°, or between about 2° and 8°, or between about 3° and 7°, or between about 4° and 6°. In other embodiments, the taper angle α₁ is about 5°, or about 6°, or about 4°. When the wall 12 is tapered, for example at angle α₁ of about 5°, the first opening 18 is smaller than the second opening 20. In one embodiment, the planting apparatus 10 can have the following dimensions. The outside diameter D₁ of the rim 14 can be about 7 inches, the inside diameter of the rim 14 and the diameter D₂ of the second opening 20 can be about 4 inches, and the diameter D₃ of the first opening 18 can be about 3.4 inches. The length L₁ of the planting apparatus 10 can be about 3.9 inches with a wall thickness of about ⅛ of an inch. The taper angle α₁ can be about 5° and the radius R₁ can be about ¼ of an inch. Many other dimensions and sizes are contemplated and are within the scope of this invention.

With reference to all the FIGURES, the operation of the planting apparatus 10 according to some embodiments will now be described. First, the planting apparatus is situated at the desired planting site. The planting apparatus 10 can be inserted into the ground G, with first end 22 inserted into the ground first, when downward pressure is applied. With first end 22 in contact with the ground G, the planting apparatus 10 can be inserted substantially straight into the ground, according to some embodiments. In some embodiments, while downward pressure is being applied the planting apparatus 10 can be turned clockwise, counter-clockwise, or in alternating directions with the first end 22 in contact with the ground G so that the projections or serrations 28 assist with inserting the planting apparatus 10 into the ground. The rim 14 can provide the gardener with a surface to grasp and push the planting apparatus 10 into the ground.

In some embodiments, the planting apparatus 10 is inserted into the ground and then temporarily withdrawn from the ground, causing the soil lodged into and contained in the cavity 16 to stay in the planting apparatus 10 as it is removed from the ground. In this embodiment, the soil is removed from the cavity 16, and the planting apparatus 10 is re-inserted into the ground again so as to operatively define a hole capable of receiving soil and a seed, seedling, or mature plant (root ball). In other embodiments, the planting apparatus 10 is inserted into the ground before being temporarily withdrawn; in the this embodiment, the soil does not stay in the cavity as the planting apparatus 10 is removed, but the temporary insertion of the planting apparatus 10 leaves a perfectly formed outline of the area to be dug; after soil is removed from the outlined digging area, the planting apparatus is reinserted so as to operatively receive a seed and soil or root ball. In still other embodiments, the gardener digs a hole approximately twice the size of the root ball intended to be transplanted into the ground, and the planting apparatus is inserted into the hole; the root ball is then inserted into the planting apparatus 10 along with any additional soil necessary to fill the area defined by the cavity 16, while the portion of the hole surrounding the planting apparatus 10 is backfilled with either the original soil, or soil amended with nutrients (as are commonly known to those persons of ordinary skill in the art). In one embodiment, the gardener partially digs a hole for plant transplant, the planting apparatus 10 is inserted, and digging continues until a hole of the desired size is accomplished; in this embodiment, the planting apparatus 10 keeps soil being turned over in the digging process from re-entering the area defined by the planting apparatus 10. In all of these embodiments, once a hole of the desired size is accomplished, a seed or root ball is planted into the hole as is well known in the art.

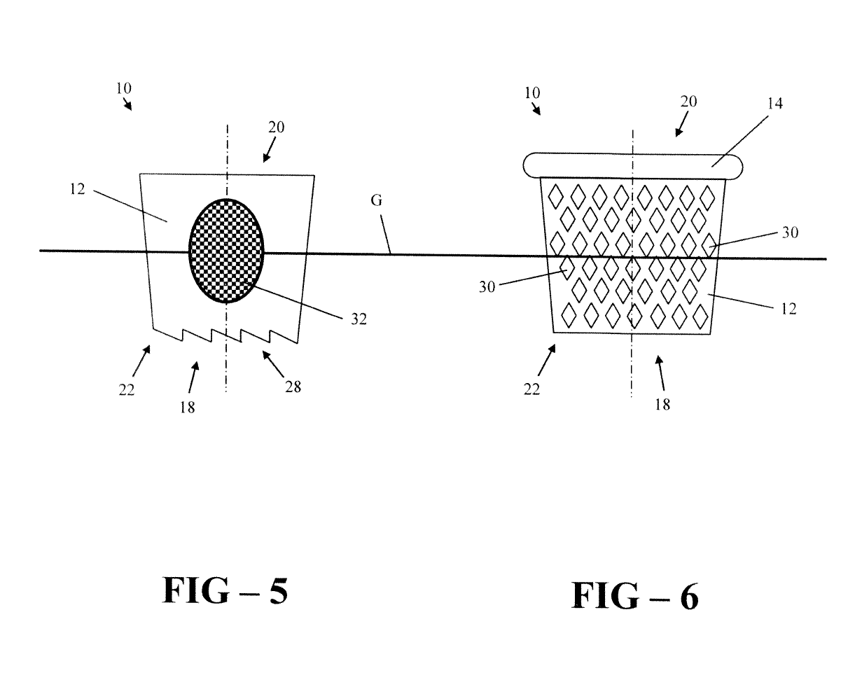

In some embodiments, a hole can be dug in the ground approximately the size and shape of the planting apparatus 10; the hole can be sized to receive the entire planting apparatus 10, or the hole can be sized to receive a portion of the planting apparatus 10; the planting apparatus 10 can then be placed at least partially in the hole. In some embodiments, substantially the entire planting apparatus 10 is placed within the ground G, as shown in FIGS. 3 and 4. In other embodiments, only a portion of the planting apparatus 10 is placed within the ground G, as shown in FIGS. 5 and 6. If the planting apparatus 10 includes serrations 28 on the first end 22, then the planting apparatus 10 can be rotated so that the serrations 28 can break-up the soil underneath the planting apparatus 10. Soil can be filled in around the planting apparatus 10 as needed.

In some embodiments, after the planting of soil and seed or a root ball is complete, the planting apparatus 10 can remain in the ground to mark the location of the plant, and/or establish boundaries for the plant, and/or provide a protection barrier from encroachment of other surrounding plants. The planting apparatus 10 can prevent the plant from spreading and invading other plants (becoming an “invasive” plant) (as is well known with some plants producing “shoots”); or can establish a raised and identifiable boundary, as shown in FIGS. 4 and 6, capable of identifying a mature plant's origin and species and protecting delicate plants from the encroachment of other plants in the garden area. The top opening 20 provides space for the plant to receive sunlight and grow upwards, while the bottom opening 18 allows the roots of the plant to extend and expand into the ground beyond the physical boundaries of the planting apparatus 10. The planting apparatus 10 can provide one or more of the following: a planting guide, garden organization, garden design, a potting for plants, plant segregation, plant identification, decoration, or protection for a plant.

In some embodiments, the planting apparatus 10 remains in the ground after plant transplant is completed. In some embodiments, the planting apparatus 10 is removed from the ground once a desired level of plant maturity is reached, thereby leaving the seed or plant in the ground. In one embodiment, the planting apparatus 10 can be partially inserted into the ground G to shield and protect a new plant or seedling or to impede it's encroachment outside of the planting site. Once the plant or seedling has grown to a point where the roots are established and the plant is strong enough to overcome encroachment of surrounding plants, the planting apparatus 10 can be removed from the ground.

In still other embodiments, as shown in FIG. 8, the planting apparatus 10 is placed over an existing seedling or transplanted plant with the rim 14 in contact with—but not inserted into—the ground. In this embodiment, the position of the curved rim 14 creates a moat 40 capable of receiving a liquid substance that deters or kills insects or slugs attempting to migrate onto the plant. When a slug, for example, tries to position itself on the plant it must first travel over the moat 40 that a gardener has filled with a liquid (in one embodiment, beer) before climbing up the wall 12 and onto the plant. The slug is either drowned or rendered incapable of such travel by the liquid contained in the rim 14, thereby maintaining the health and well-being of a protected plant.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A planting apparatus comprising:
a wall having a first end and a second end surrounding a cavity adapted to receive a plant seed or root ball, wherein the wall's first end defines a first opening adapted to permit unobstructed plant root growth into the soil, and the wall's second end defines a second opening adapted to permit unobstructed growth of the plant's stem in an upward direction; and
a rim, adapted to securely transfer downward pressure, attached to the wall's second end and extending in a substantially perpendicular direction away from the cavity.

2. The planting apparatus of claim 1, wherein the wall is cylindrical and the rim is circular.

3. The planting apparatus of claim 2, wherein the first opening and second opening are of equal diameter.

4. The planting apparatus of claim 3, wherein the rim contains apertures adapted to receive a component chosen from the group comprising: identification markers, information markers, or garden decorations.

5. The planting apparatus of claim 3, wherein the rim is covered in a grip substance.

6. The planting apparatus of claim 3, wherein the wall contains a measurement gauge.

7. The planting apparatus of claim 3, wherein the wall's first end has a sharpened edge.

8. The planting apparatus of claim 3, wherein the wall's first end has serrations.

9. The planting apparatus of claim 3, wherein the wall contains one or more apertures adapted to permit lateral root growth out of the planting apparatus.

10. The planting apparatus of claim 2, wherein the outside diameter of the rim is 7.84 inches, the inside diameter of the rim and the diameter of the second opening 20 is 4.5 inches; the diameter D₃ of the first opening is 4.5 inches, and the length of the planting apparatus is 4.75 inches, with a wall thickness of 0.09 of an inch.

11. The planting apparatus of claim 2, wherein the wall has a taper from the wall's second end to the wall's first end, so that the first opening is smaller than the second opening.

12. The planting apparatus of claim 11, wherein the wall 12 has a taper angle of between 0° and 10°.

13. The planting apparatus of claim 11, wherein the outside diameter of the rim 14 is 7 inches, the inside diameter of the rim and the diameter of the second opening is 4 inches, the diameter of the first opening is 3.4 inches, the length of the planting apparatus is 3.9 inches, the wall thickness is ⅛ of an inch, the taper angle is 5°, and the radius R₁ is ¼ of an inch.

14. A method for planting a seed or root ball, comprising the steps of:
A. Providing a bottomless planting pot with a first end and a second end;
B. Placing the first end of the bottomless planting pot on aground surface at a planting site;
C. Applying downward pressure to the planting pot's second end until the first end is at least partially inserted into the ground;
D. Removing the bottomless planting pot;
E. Removing all soil from the planting site;
F. Re-inserting the bottomless planting pot into the planting site;
G. Planting a seed or root ball into the planting site.

15. The method of claim 14, wherein steps A-G are performed sequentially.

16. The method of claim 14, wherein:
Step C additionally comprises soil becoming lodged within the bottomless planting pot upon insertion into the ground; and
Step E additionally comprises evacuation of soil lodged within the bottomless planting pot upon its removal.

17. The method of claim 14, additionally comprising the step of:
H. Removing the bottomless planting pot from the planting site once the seed has matured to a desired condition.

18. The method of claim 14, wherein the planting site of Step B is a hole dug into the ground surface, and Step D is unnecessary.

19. The method of claim 17, additionally comprising the step of removing the bottomless planting pot from the planting site once the seed has matured to a desired condition.

20. A method of preventing slugs from damaging garden plants, comprising the steps of:
A. Providing a bottomless planting pot with a first end, a second end, and a curved rim; wherein the curved rim is attached to the second end on a perpendicular plane and curves towards the first end;
B. Placing the curved rim of the bottomless planting pot on a ground surface surrounding a planting site containing a plant;
C. Filling the curved rim with beer to prevent slugs from migrating onto the plant.
